(19) United States
(12) Patent Application Publication
(10) Pub. No.: US 2014/0324888 A1
(43) Pub. Date: Oct. 30, 2014

(54) Method and Apparatus for Identifying a Gesture Based Upon Fusion of Multiple Sensor Signals

(71) Applicant: Nokia Corporation, Espoo (FI)

(72) Inventors: Xiaohui Xie, Beijing (CN); Yikai Fang, Beijing (CN); Kongqiao Wang, Beijing (CN); Terhi Tuulikki Rautiainen, Vantaa (FI)

(21) Appl. No.: 14/361,439

(22) PCT Filed: Dec. 9, 2011
(86) PCT No.: PCT/CN2011/083759

§ 371 Date: May 29, 2014

(51) Int. Cl. G06F 3/01; G06F 17/30

(52) U.S. Cl. CPC G06F 3/017; G06F 17/30595
USPC 707/748

(57) ABSTRACT

A method, apparatus and computer program product are provided to permit improve gesture recognition based on fusion of different types of sensor signals. In the context of a method, a series of image frames and a sequence of radar signals are received. The method determines an evaluation score for the series of image frames that is indicative of a gesture. This determination of the evaluation score may be based on the motion blocks in an image area and the shift of the motion blocks between image frames. The method also determines an evaluation score for the sequence of radar signals that is indicative of the gesture. This determination of the evaluation score may be based upon the sign distribution in the sequence and the intensity distribution in the sequence. The method weighs each of the evaluation scores and fuses the evaluation scores, following the weighting, to identify the gesture.

### TECHNOLOGICAL FIELD

An example embodiment of the present invention relates generally to user interface technology and, more particularly, to a method, apparatus and computer program product for identifying a gesture.

### BACKGROUND

In order to facilitate user interaction with a computing device, user interfaces have been developed to respond to gestures by the user. Typically, these gestures are intuitive and therefore serve to facilitate the use of the computing device and to improve the overall user experience. The gestures that may be recognized by a computing device may serve numerous functions, such as to open a file, close a file, move to a different location within the file, increase the volume, etc. One type of gesture that may be recognized by a computing device is a hand wave. A hand wave may be defined to provide various types of user input including, for example, navigational commands to control a media player, gallery browsing or a slide presentation.

Computing devices generally provide for gesture recognition based upon the signals provided by a single sensor, such as a camera, an accelerometer or a radar sensor. By relying upon a single sensor, however, computing devices may be somewhat limited in regards to the recognition of gestures. For example, a computing device that relies upon a camera to capture images from which a gesture is recognized may have difficulty in adapting to changes in the illumination as well as the white balance within the images captured by the camera. Also, computing devices that rely upon an accelerometer or gyroscope to provide the signals from which a gesture is recognized cannot detect the gesture in an instance in which the computing device itself is fixed in position. Further, a computing device that relies upon a radar sensor to provide the signals from which a gesture is identified may have difficulties in determining what the object that makes the gesture actually is.

### BRIEF SUMMARY

A method, apparatus and computer program product are therefore provided according to an example embodiment in order to provide for improved gesture recognition based upon the fusion of signals provided by different types of sensors. In one embodiment, for example, a method, apparatus and computer program product are provided in order to recognize a gesture based upon the fusion of signals provided by a camera or other image capturing device and a radar sensor. By relying upon the signals provided by different types of sensors and by appropriately weighting the evaluation scores associated with the signals provided by the different types of sensors, a gesture may be recognized in a more reliable fashion with fewer limitations than computing devices that have relied upon a single sensor for the recognition of a gesture.

In one embodiment, a method is provided that includes receiving a series of image frames and receiving a sequence of radar signals. The method of this embodiment also determines an evaluation score for the series of image frames that is indicative of a gesture. In this regard, the determination of the evaluation score may include determining the evaluation score based on the motion blocks in an image area and the shift of the motion blocks between image frames. The method of this embodiment also includes determining an evaluation score for the sequence of radar signals that is indicative of the gesture. In this regard, the determination of the evaluation score may include determining the evaluation score based upon the sign distribution in the sequence and the intensity distribution in the sequence. The method of this embodiment also weighs each of the evaluation scores and fuses the evaluation scores, following the weighting, to identify the gesture.

The method may determine the evaluation score for the series of image frames by down-sampling image data to generate down-sampled image blocks for the series of image frames, extracting a plurality of features from the down-sampled image blocks and determining a moving status of the down-sampled image blocks so as to determine the motion blocks based upon changes in values of respective features in consecutive image frames. In this regard, the method may also determine a direction of motion of the gesture based on movement of a first border and a second border of a projection histogram determined based on the moving status of respective down-sampled image blocks.

The method of one embodiment may determine the evaluation score for the series of image frames by determining the evaluation score based on a ratio of average motion blocks in the image area. The intensity of the radar signals may depend upon the distance between an object that makes the gesture and the radar sensor, while a sign associated with the radar signals may depend upon the direction of motion of the object relative to the radar sensor. Weighting each of the evaluation scores may include determining weighs to be associated with the evaluation scores based upon linear discriminate analysis, Fisher discriminate analysis or a linear support vector machine. The method of one embodiment may also include determining a direction of motion of the gesture based upon the series of image frames in an instance in which the gesture is identified.

In another embodiment, an apparatus is provided that includes at least one processor and at least one memory including computer program code with the memory and the computer program code being configured to, with the processor, cause the apparatus to receive a series of image frames and to receive a sequence of radar signals. The at least one memory and the computer program code of this embodiment are also configured to, with the processor, cause the apparatus to determine an evaluation score for the series of image frames that is indicative of a gesture by determining the evaluation score based upon the motion blocks in an image area and a shift of motion blocks between image frames. The at least one memory in the computer program code of this embodiment are also configured to, with the processor, cause the apparatus to determine an evaluation score for the sequence of radar signals that is indicative of the gesture by determining the evaluation score based upon sign distribution in the sequence and the intensity distribution in the sequence. The at least one memory and the computer program code of this embodiment are also configured to, with the processor, cause the apparatus to weight each of the evaluation scores and fuse the evaluation scores, following the weighting, to identify the gesture.

The at least one memory and the computer program code are also configured to, with the processor, cause the apparatus of one embodiment to determine the evaluation score for the series of image frames by down-sampling image data to generate down-sampled image blocks for the series of image frames, extracting a plurality of features from the down-sampled image blocks and determining a moving status of the down-sampled image blocks so as to determine the motion blocks based upon changes in values of respective features in consecutive image frames. The at least one memory in the computer program code of this embodiment may be further configured to, with the processor, cause the apparatus to determine a direction of motion of the gesture based on movement of a first border and the second border of a projected histogram determined based on the moving status of respective down-sampled image blocks.

The at least memory and the computer program code of one embodiment may be configured to, with the processor, cause the apparatus to determine an evaluation score from a series of image frames by determining the evaluation score based upon a ratio of average motion blocks in the image area. The intensity of the radar signals may depend upon the distance between an object that makes the gesture and the radar sensor, while a sign associated with the radar signals may depend upon a direction of motion of the object relative to the radar signals. The at least one memory and the computer program code are configured to, with the processor, cause the apparatus of one embodiment to weight each of the evaluation scores by determining weights to be associated with the evaluation scores based upon linear discriminate analysis, Fisher discriminate analysis or a linear support vector machine. The at least one memory and the computer program code are further configured to, with the processor, cause the apparatus of one embodiment to determine a direction of motion of the gesture based upon the series of image frames in an instance in which the gesture is identified. The apparatus of one embodiment may also include user interface circuitry configured to facilitate user control of at least some functions of the apparatus through use of a display and cause at least a portion of the user interface of the apparatus to be displayed on the display to facilitate user control of at least some functions of the apparatus.

In a further embodiment, a computer program product is provided that includes at least one computer-readable storage medium having a computer-executable program code portions stored therein with the computer-executable program code portions including program instructions configured to receive a series of image frames and to receive a sequence of radar signals. The program instructions of this embodiment are also configured to determine an evaluation score for the series of image frames that is indicative of a gesture by determining the evaluation score based upon motion blocks in an image area and the shift of motion blocks between image frames. The program instructions of this embodiment are also configured to determine an evaluation score for the sequence of radar signals that is indicative of the gesture by determining the evaluation score based upon the sign distribution in sequence and the intensity distribution in the sequence. The program instructions of this embodiment are also configured to weigh each of the evaluation scores and to fuse the evaluation scores, following the weighing, to identify the gesture.

The computer-executable program portion to one embodiment may also include program instructions configured to determine the evaluation score for the series of image frames by down-sampling image data to generate down-sampled image blocks for the series of image frames, extracting a plurality of features from the down-sampled image blocks and determining a moving status of the down-sampled image blocks so as to determine the motion blocks based upon changes in values of respective features in consecutive images. The computer-executable program portion of this embodiment may also include program instructions configured to determine a direction of motion of the gesture based on movement of the first border and a second border of a projection histogram determined based on the moving status of respective down-sampled image blocks.

The program instructions that are configured to determine an evaluation score for the series of image frames in accordance with one embodiment may include program instructions configured to determine the evaluation score based upon a ratio of the average motion blocks in the image area. The radar signals may have an intensity that depends upon a distance between an object that makes the gesture on the radar sensor and a sign that depends upon a direction of motion of the object relative to the radar sensor. The program instructions that are configured to weight each of the evaluation scores may include, in one embodiment, program instructions configured to determine weights to be associated with the evaluation scores based upon linear discriminate analysis, Fisher discriminate analysis or a linear support vector machine. The computer-executable program code portions of one embodiment may also include program instructions configures to determine a direction of motion of the gesture based upon the series of image frames in an instance in which the gesture is identified.

In yet another embodiment, an apparatus is provided that includes means for receiving a series of image frames and means for receiving a sequence of radar signals. The apparatus of this embodiment also includes means for determining an evaluation score for the series of image frames that is indicative of a gesture. In this regard, the means for determining the evaluation score may determine the evaluation score based upon the motion blocks in an image area and a shift of motion blocks between image frames. The apparatus of this embodiment also includes means for determining an evaluation score for the sequence of radar signals as indicative of the gesture. In this regard, the means for determining the evaluation score may determine the evaluation score based upon the sign distribution in the sequence and the intensity distribution in the sequence. The apparatus of this embodiment also includes means for weighting each of the evaluation scores and means for fusing the evaluation scores, following the weighting, to identify the gesture.

### BRIEF DESCRIPTION OF THE SEVERAL VIEWS OF THE DRAWINGS

Having thus described certain example embodiments of the present invention in general terms, reference will now be made to the accompanying drawings, which are not necessarily drawn to scale, and wherein:

FIG. 1 is a block diagram of an apparatus for identifying a gesture based upon signals from at least two sensors according to an example embodiment of the present invention;

FIG. 2 is a flowchart of the operations performed in accordance with an example embodiment of the present invention;

FIG. 3 is a flowchart of the operations performed in order to evaluate a series of image frames;

FIG. 4 illustrates three sequential image frames that each include a plurality of motion blocks with the image frame shifting from the right to the left between the image frames;

FIG. 5 is a schematic representation of various gestures with respect to a display plane as defined by an apparatus in accordance with an example embodiment of the present invention; and

FIG. 6 is a schematic representation of a gesture plane relative to a radar sensor.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

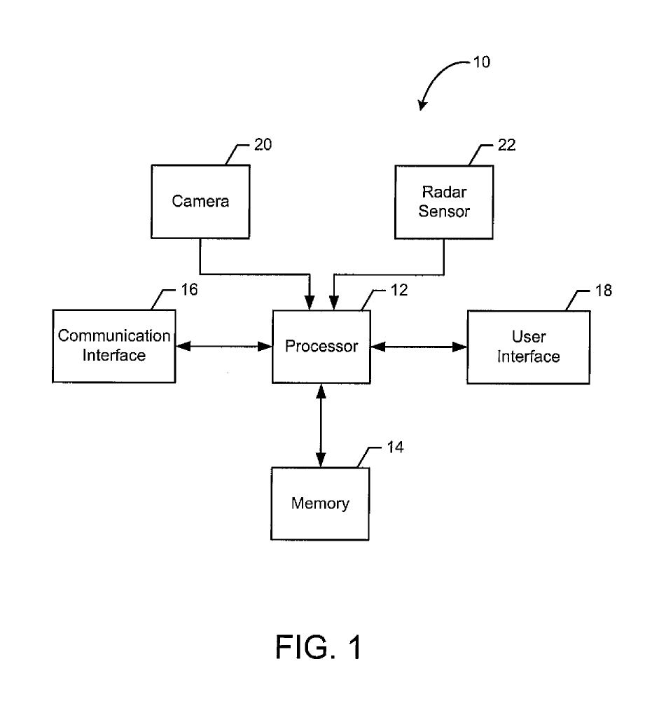

As described below, a method, apparatus and computer program product are provided that permit a gesture, such as a hand wave, to be identified based upon the fusion of multiple and different types of sensor signals. For example, the method, apparatus and computer program product of one embodiment may identify a gesture based upon the fusion of sensor signals from a camera or other image capturing device and sensor signals from a radar sensor. As described below, the apparatus that may identify a gesture based upon the fusion of sensor signals may, in one example embodiment, be configured as shown in FIG. 1. While the apparatus of FIG. 1 may be embodied in a mobile terminal such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, it should be noted that the apparatus of FIG. 1 may also be embodied in a variety of other devices, both mobile and fixed, and therefore embodiments of the present invention should not be limited to application on mobile terminals.

It should also be noted that while FIG. 1 illustrates one example of a configuration of an apparatus 10 for identifying a gesture based upon the fusion of sensor signals, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 1, the apparatus 10 for identifying a gesture based upon the fusion of sensor signals may include or otherwise be in communication with a processor 12, a memory 14, a communication interface 16 and optionally a user interface 18. In some embodiments, the processor 12 (and/or co-processors or any other processing circuitry assisting or otherwise associated with the processor) may be in communication with the memory 14 via a bus for passing information among components of the apparatus 10. The memory 14 may include, for example, one or more volatile and/or non-volatile memories. In other words, for example, the memory 14 may be an electronic storage device (e.g., a computer readable storage medium) comprising gates configured to store data (e.g., bits) that may be retrievable by a machine (e.g., a computing device like the processor 12). The memory 14 may be configured to store information, data, content, applications, instructions, or the like for enabling the apparatus 10 to carry out various functions in accordance with an example embodiment of the present invention. For example, the memory 14 could be configured to buffer input data for processing by the processor 12. Additionally or alternatively, the memory 14 could be configured to store instructions for execution by the processor 12.

The apparatus 10 may, in some embodiments, be a user terminal (e.g., a mobile terminal) or a fixed communication device or computing device configured to employ an example embodiment of the present invention. However, in some embodiments, the apparatus 10 or at least components of the apparatus, such as the processor 12, may be embodied as a chip or chip set. In other words, the apparatus 10 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 10 may therefore, in some cases, be configured to implement an embodiment of the present invention on a single chip or as a single “system on a chip.” As such, in some cases, a chip or chipset may constitute means for performing one or more operations for providing the functionalities described herein.

The processor 12 may be embodied in a number of different ways. For example, the processor 12 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 12 may include one or more processing cores configured to perform independently. A multi-core processor may enable multiprocessing within a single physical package. Additionally or alternatively, the processor 12 may include one or more processors configured in tandem via the bus to enable independent execution of instructions, pipelining and/or multithreading.

In an example embodiment, the processor 12 may be configured to execute instructions stored in the memory 14 or otherwise accessible to the processor. Alternatively or additionally, the processor 12 may be configured to execute hard coded functionality. As such, whether configured by hardware or software methods, or by a combination thereof, the processor 12 may represent an entity (e.g., physically embodied in circuitry) capable of performing operations according to an embodiment of the present invention while configured accordingly. Thus, for example, when the processor 12 is embodied as an ASIC, FPGA or the like, the processor may be specifically configured hardware for conducting the operations described herein. Alternatively, as another example, when the processor 12 is embodied as an executor of software instructions, the instructions may specifically configure the processor 12 to perform the algorithms and/or operations described herein when the instructions are executed. However, in some cases, the processor 12 may be a processor of a specific device (e.g., a mobile terminal) configured to employ an embodiment of the present invention by further configuration of the processor 12 by instructions for performing the algorithms and/or operations described herein. The processor 12 may include, among other things, a clock, an arithmetic logic unit (ALU) and logic gates configured to support operation of the processor.

Meanwhile, the communication interface 16 may be any means such as a device or circuitry embodied in either hardware or a combination of hardware and software that is configured to receive and/or transmit data from/to a network and/or any other device or module in communication with the apparatus 10. In this regard, the communication interface 16 may include, for example, an antenna (or multiple antennas) and supporting hardware and/or software for enabling communications with a wireless communication network. Additionally or alternatively, the communication interface 16 may include the circuitry for interacting with the antenna(s) to cause transmission of signals via the antenna(s) or to handle receipt of signals received via the antenna(s). In some environments, the communication interface 16 may alternatively or also support wired communication. As such, for example, the communication interface 16 may include a communication modem and/or other hardware/software for supporting communication via cable, digital subscriber line (DSL), universal serial bus (USB) or other mechanisms.

In some embodiments, such as instances in which the apparatus 10 is embodied by a user device, the apparatus may include a user interface 18 that may, in turn, be in communication with the processor 12 to receive an indication of a user input and/or to cause provision of an audible, visual, mechanical or other output to the user. As such, the user interface 18 may include, for example, a keyboard, a mouse, a joystick, a display, a touch screen(s), touch areas, soft keys, a microphone, a speaker, or other input/output mechanisms. Alternatively or additionally, the processor 12 may comprise user interface circuitry configured to control at least some functions of one or more user interface elements such as, for example, a speaker, ringer, microphone, display, and/or the like. The processor 12 and/or user interface circuitry comprising the processor may be configured to control one or more functions of one or more user interface elements through computer program instructions (e.g., software and/or firmware) stored on a memory accessible to the processor (e.g., memory 14, and/or the like). In other embodiments, however, the apparatus 10 may not include a user interface 18.

The apparatus 10 may include or otherwise be associated or in communication with a camera 20 or other image capturing element configured to capture a series of image frames including images of a gesture, such as a hand wave. In an example embodiment, the camera 20 is in communication with the processor 12. As noted above, the camera 20 may be any means for capturing an image for analysis, display and/or transmission. For example, the camera 20 may include a digital camera capable of forming a digital image file from a captured image. As such, the camera 20 includes all hardware, such as a lens or other optical device, and software necessary for creating a digital image file from a captured image. Alternatively, the camera 20 may include only the hardware needed to view an image, while the memory 14 stores instructions for execution by the processor 12 in the form of software necessary to create a digital image file from a captured image. In an example embodiment, the camera 20 may further include a processing element such as a co-processor which assists the processor 12 in processing image data and an encoder and/or decoder for compressing and/or decompressing image data. The encoder and/or decoder may encode and/or decode according to a joint photographic experts group (JPEG) standard format. The images that are recorded may be stored for future viewings and/or manipulations in the memory 14.

The apparatus 10 may also include or otherwise be associated or in communication with a radar sensor 22 configured to capture a sequence of radar signals indicative of the presence and movement of an object, such as the hand of a user that is making a gesture, such as a hand wave. Radar supports an object detection system that utilizes electromagnetic waves, such as radio waves, to detect the presence of objects, their speed and direction of movement, as well as their range from the radar sensor 22. Emitted waves which bounce back, e.g., reflect, from an object are detected by the radar sensor 22. In some radar systems, the range to an object may be determined based on the time difference between the emitted and reflected waves. Additionally, movement of the object toward or away from the radar sensor 22 may be detected through the detection of a Doppler shift. Further, the direction to an object may be determined by radar sensors 22 with two or more receiver channels by angle estimation methods, for example, beamforming. The radar sensor 22 may be embodied by any of a variety of radar devices, such as a Doppler radar system, a frequency modulated continuous wave (FMCW) radar or an impulse/ultra wideband radar.

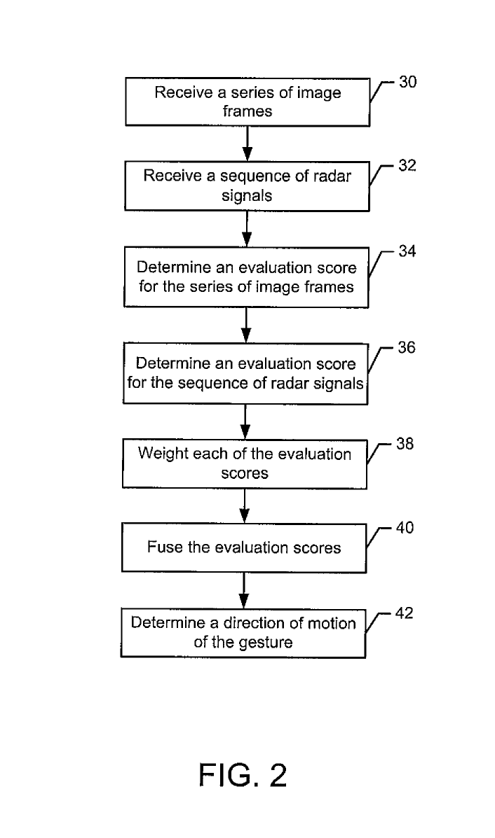

The operations performed by a method, apparatus and computer program product of one example embodiment may be described with reference to the flowchart of FIG. 2. In this regard, block 30 of FIG. 2 illustrates that the apparatus 10 may include means, such as an image capturing device, e.g., a camera 20, a processor 12 or the like, for receiving a series of image frames. In this regard, the series of image frames may be a series of sequential image frames. As shown in block 32 of FIG. 2, the apparatus 10 of this embodiment may also include means, such as a radar sensor 22, the processor 12 or the like, for receiving a sequence of radar signals. The radar sensor 22 and the image capturing device, e.g., camera 20, generally operate contemporaneously and typically have a common field of view such that the resulting image frames and the radar signals provide information regarding the same gesture.

The series of image frames and the sequence of radar signals may then be processed and respective evaluation scores may be determined for the series of image frames and for the sequence of radar signals. In this regard, the evaluation score for the series of image frames may be indicative of a gesture in that the evaluation score provides an indication as to the likelihood that a gesture was recognized within the series of image frames. Similarly, the evaluation score that is determined for the sequence of radar signals provides an indication as to the likelihood that a gesture was recognized within the sequence of radar signals.

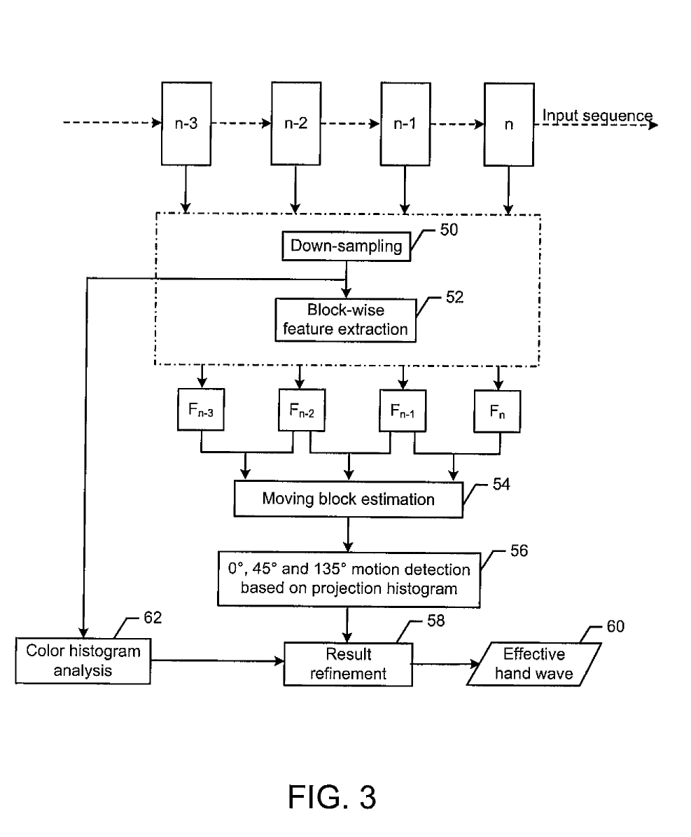

In this regard and as shown in block 34 of FIG. 2, the apparatus 10 may also include means, such as the processor 12 or the like, for determining an evaluation score for the series of image frames that is indicative of a gesture. In this regard, the determination of the evaluation score for the series of image frames may be based upon the motion blocks in an image area and the shift of the motion blocks between image frames. In order to determine the evaluation score for the series of image frames, the apparatus 10, such as the processor 12, of one embodiment may perform a motion block analysis so as to identify the motion blocks in the image area with the motion blocks then being utilized determine the evaluation score. While the image frames may be analyzed and the motion blocks identified in accordance with various techniques, the apparatus 10, such as the processor 12, of one embodiment may identify the motion blocks in the image area in the manner illustrated in FIG. 3 and described below.

In this regard and as shown in FIG. 3, an input sequence of data (e.g., illustrated by n to n-3 in FIG. 3) may be received for preprocessing as represented by the dashed block in FIG. 3. The preprocessing may generally include operations of down-sampling at operation 50 and feature extraction (e.g., block-wise feature extraction) at operation 52. After feature extraction, moving block estimation may be conducted at operation 54 with respect to each of the various different features (e.g., features Fₙ, Fₙ₋₂, Fₙ₋₃, etc.). Thereafter, at operation 56, motion detection may be performed based on a projection histogram. In some embodiments, the histograms may be computed for various different directions of motion (e.g., entirely horizontal or 0 degree motion, 45 degree motion, 135 degree motion and/or any other suitable or expected directions that may be encountered). At operation 58, the results may be refined to verify detection results. In an example embodiment, color histogram analysis may be utilized at operation 62 to assist in result refinement. Thereafter, at operation 60, an effective gesture (e.g., a hand wave) may be recognized.

In some embodiments, the preprocessing may include down-sampling, as indicated above, in order to reduce the influence that could otherwise be caused by pixel-wise noise. In an example embodiment, each input image may be smoothed and down-sampled such that a mean value of a predetermined number of pixels (e.g., a patch with 4-pixels height) may be assigned to a corresponding pixel of a down-sampled image. Thus, in an example, the working resolution would be 1/16 of the input one. In an example case, for a working image, F_{i,j}, where 1≦i≦H, 1≦j≦W, where W and H are the width and height of the image, respectively, if given a length λ (10 in one example), the image can be partitioned into M×N square blocks z_{i,j} with 1≦i≦M and 1≦j≦N, where M=H/λ and N=W/λ, then for each block, various statistical characteristics may be computed with respect to red, green and blue channels descriptive of the pixel values within the down-sampled image. A plurality of features may then be extracted from the down-sampled image. In an example embodiment, the following 6 statistical characteristics (or features) may be computed including; the mean of the luminance L, the variance of the luminance L, the mean of the red channel R, the mean of the green channel G, the mean of the blue channel B, and the mean of normalized red channel NR. The normalized red value may be computed as shown in equation 1 below:

nr=255*r/(r+g+b) (1)

where r, g and b are values of the original three channels, respectively. An example embodiment has shown that the normalized red value may often be the simplest value that may be used to approximately describe the skin color in a phone camera environment. Normally, for a typical skin area (e.g. a hand and/or a face) in the image, the normalized red value will be rather large one, compared with those of the background objects.

Moving block estimation may then be performed with respect to the data corresponding to the 6 statistical characteristics (or features) extracted in the example described above. For gesture detection such as a hand wave detection, the moving status of blocks may be determined by checking for changes between the blocks of a current frame and a previous frame.

More specifically, a block Z_{i,j,t} (where t denotes the index of frame) may be regarded as a moving block, if

(1) |L_{i,j,t}−L_{i,j,t-1}|>ƒ₁ or NR_{i,j,t}−NR_{i,j,t-1}>θ₂. This condition stresses the difference between the consecutive frames.

(2) LV_{i,j,t}<θ₃. This condition is based on the fact that the hand area typically has a uniform color distribution.

(3) R_{i,j,t}>θ₄

(4) R_{i,j,t}>θ₅*G_{i,j,t} and R_{i,j,t}22 θ₅*B_{i,j,t}

(5) R_{i,j,t}>θ₆*G_{i,j,t} or R_{i,j,t}>θ₆*B_{i,j,t}

Of note, conditions (3-5) show that the red channel typically has a relatively larger value compared with the blue and green channels.

(6) θ₇<L_{i,j,t}<θ₈. This is an empirical condition to discard the most evident background objects. In an example embodiment, the above θ₁-θ₈ may be set as 15, 10, 30, 10, 0.6, 0.8, 10 and 240, respectively.

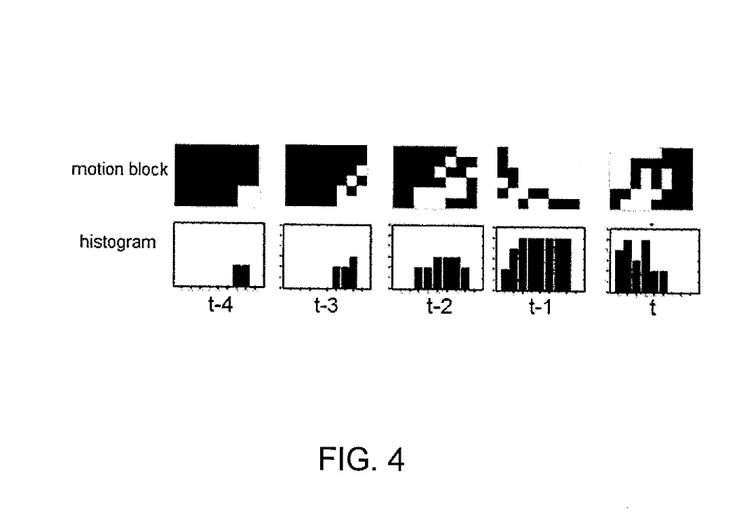

FIG. 4 illustrates a sample image sequence and corresponding image results according to an example embodiment. Based on the sample image sequence, a determination of moving blocks (e.g., the white blocks in each difference image of FIG. 4) may then be made so that a series of histograms may be determined to illustrate the movement of a hand from the right side of the image over to the left side of the image. In this regard, FIG. 4 depicts a sequence of five image frames with moving blocks that were captured at t, t-1, t-2, t-3 and t-4 as well as the corresponding vertical histograms. The detection of motion may be refined in some cases since the area of a hand may typically be larger than the block size. In this regard, for example, the moving blocks may be further refined based on their topology. In an example embodiment, a block without any moving blocks in its 8-connected-block neighborhood may be regarded as a non-moving block. Thus, for example, in an case where there are moving blocks Ωₜ={Zᵢ|Mov(Zᵢ)=1} for a current frame, where Mov(Z)=1 means that block Z is a moving block, histogram analysis may be employed to determine different types of gestures (e.g., different types of hand waves such as left-to-right, up-to-down, forward-to-backward, or vice versa). A specific example for left-to-right detection is described below, however; modifications for employment with the other types can be derived based on the example shown. For a right hand wave, the N-dimensional vertical projection histogram may be computed as:

$${H}_{i , t} = {\sum }_{j = 1}^{M} Mov ( {Z}_{j , i , t} ) , \\ 1 \leq i \leq N \qquad ( 3 )$$

The left border BLₜ and right border BRₜ of the histogram may be determined by

$$\begin{matrix}{BL}_{t} = {min}_{i} ( {H}_{i , t} > 0 ) & ( 4 ) \\ {BR}_{t} = {max}_{i} ( {H}_{i , t} > 0 ) . & ( 5 )\end{matrix}$$

With respect to the sequential image frames designated as t, t-1 and t-2 in FIG. 4, the process may be repeated for the t-2 and t-1 frames. Based on the data from the latest three frames, the direction of the hand wave can be determined. More specifically, if the following two conditions are satisfied, it may be determined that the detected motion corresponds to a right wave in the sequence:

(1) BRₜ>BRₜ₋₁+1 and H_{BL}_{ₜ₋₁}_{+1,t-1}+H_{BL}_{ₜ₋₁}_{,t-1}≧3

(2) BRₜ>BRₜ₋₂+1 and H_{BL}_{ₜ₋₂}_{+1,t-2}+H_{BL}_{ₜ₋₂}_{,t-2}≧3 and |H_{i,t-1}|>3.

However, if the two conditions below are satisfied instead, it may be determined that a left wave has occurred in the sequence:

(3) BLₜ<BLₜ₋₁−1 and H_{BR}_{ₜ₋₁}_{31 1,t-1}+H_{BR}_{ₜ₋₁}_{-1,t-1}+H_{BR}_{ₜ₋₁}_{,t-1}≧3

(4) BLₜ<BLₜ₋₂−1 and H_{BR}_{ₜ₋₂}_{-1,t-2}+H_{BR}_{ᵢ₋₂}_{,t-2}≧3 and |H_{i,t-1}|>3.

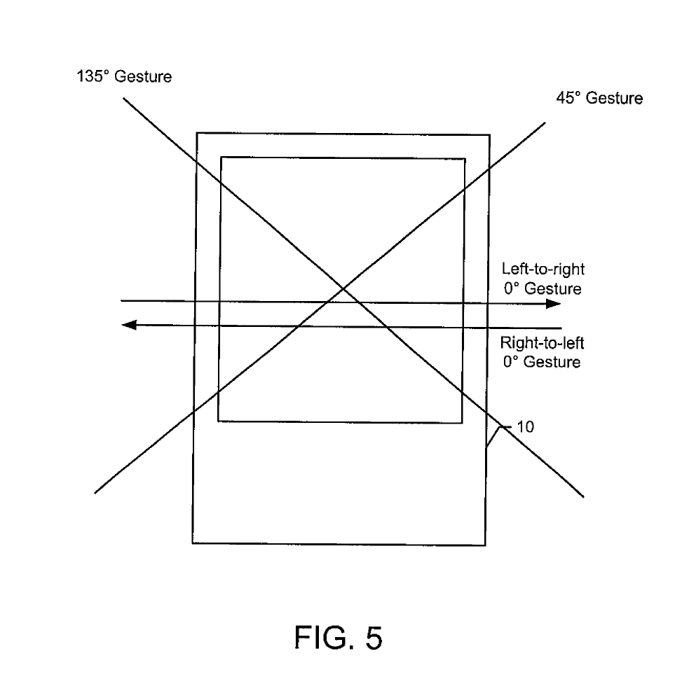

To deal with cases in which the track of a hand is not entirely horizontal, such as the 0 degree left-to-right movement and the 0 degree right-to-left movement shown in FIG. 5, 45 degree histograms for 45 degree gestures, 135 degree histograms for 135 degree gestures and/or the like may be computed for detection as well. See, for example, FIG. 5 which illustrates 45 degree and 135 degree gestures. As an example, for a 45 degree histogram, the expression (3) above may be replaced by:

$${H}_{k , t} = {\sum }_{i = 1}^{N} {\sum }_{j = 1}^{M} ( Mov ( {Z}_{j , i , t} ) \vert i + j = k ) , \\ 2 \leq k \leq M + N \qquad ( 6 )$$

Similarly, equation (7) may be employed for use in 135 degree histograms:

$${H}_{k , t} = {\sum }_{i = 1}^{N} {\sum }_{j = 1}^{M} ( Mov ( {Z}_{j , i , t} ) \vert j - i = k ) , \\ 1 - N \leq k \leq M - 1. \qquad ( 7 )$$

The conditions above (with or without modifications for detection of angles other than 0 degrees) may be used for hand wave detection in various different orientations. An example of the vertical histograms associated with a series of image frames with moving blocks is shown FIG. 4. For a forward-to-backward hand wave, the vertical histogram may be replaced with a horizontal histogram and equations (6) and (7) may be used similarly to estimate direction when the track of the hand is not entirely vertical. Another type of gesture that is discussed below is an up-down gesture. In this regard and with reference to FIG. 5, a forward-to-backward gesture and an up-down gesture may be based upon the orientation of the user and/or the direction of gravity as opposed to the orientation of the display plane defined by the apparatus 10. In this regard, in in instance in which the apparatus is laid upon a table or other horizontal surface with the camera 20 facing upwardly such that the display plane lies in a horizontal plane, an up-down gesture results from movement of the hand toward and away from the apparatus in a direction perpendicular to the display plane, while a forward-to-backward gesture results from movement in a plane parallel to the display plane. Conversely, if the apparatus is positioned vertically, such as in an instance in which the apparatus is placed on the console while in a vehicle such that the display plane lies in a vertical plane, the up-down gesture will result from movement of the hand upwardly and downwardly relative to gravity in a plane parallel to the display plane, while the forward-to-backward gesture results from movement in a plane perpendicular to the display plane.

To eliminate or reduce the likelihood of false alarms caused by background movement (which may occur in driving environments or other environments where the user is moving), the region-wise color histogram may also be used to verify detection (as indicated in operation 62 of FIG. 3). In this regard, it may be expected that a hand wave would cause a large color distribution change. Thus, some example embodiments may device a frame into a predetermined number of regions or sub-regions (e.g., 6 sub-regions in one example) and a three dimensional histogram regarding the RGB (red, green and blue) values may be determined for each sub-region. To make the histogram more stable, each channel of RGB may be down-scaled from 256 to 8, to provide six, 512-dimensional histograms, e.g., HC_{1,t}, HC_{2,t}, HC_{3,t}, HC_{4,t}, HC_{5,t}, HC_{6,t}.

After detection of a hand wave, HC_{1,t}-HC_{6,t} may be used for verification. Specifically, for example, if an ith sub-region contains moving blocks, the squared Euclidean distance may be computed between HC_{i,t} and HC_{i,t-1}.

Once the motion blocks have been identified, the apparatus 10, such as the processor 12, of one embodiment may determine the ratio of average effective motion blocks in the image area. The ratio of average effective motion blocks in the image area may be defined as the average percentage of motion blocks in each image of the series of image frames. As shown in FIG. 4, for example, a series of five image frames is shown. In the image frames of FIG. 4, the motion blocks are represented by white squares, while the blocks of the image frames that were not determined to be motion blocks being shaded, that is, being shown in black. As such, in the initial image frame of this sequence, that is, the leftmost image frame of FIG. 4 designated t-4, the image area includes four motion blocks. As will be seen in the other image frames of FIG. 4, image frame t-3 includes 7 motion blocks, image frame t-2 includes 15 motion blocks, image frame t-1 includes 36 motion blocks and image frame t includes 21 motion blocks. Since each image frame includes six rows of eight blocks for a total of 48 blocks, the average percentage of effective moving blocks in the image area in this example is 0.41.

The apparatus 10, such as the processor 12, of one embodiment may also determine the shift of the motion blocks between image frames, such as between temporally adjacent image frames. In an image frame, such as shown in FIG. 4, that includes projection histograms, the direction of motion of a gesture may be based on the movement of a first border and a second border of the projection histogram between the image frames. In this regard, the first border may be the left border BLₜ and the second border may be the right border BRₜ, as described above. In the image frames shown in FIG. 4, for example, the left border of the motion block histogram for frame t is 1, while the left border of the motion block histogram for frame t-3 is 6. The shift distance in this context is determined based upon the distance that the border moves across the sequence, such as 5 frames, e.g., 6-1, as opposed to the distance that the distance moves between two adjacent frames. In this embodiment, it is noted that frame t-4 is set aside and not considered since the frame the number of motion blocks, e.g., 4, is less than a minimum number of motion blocks. As described below, the minimum number of motion blocks may be defined, in one embodiment, as Aₜₒₜₐₗ*Pₘᵢₙ with Aₜₒₜₐₗ being the total number of blocks in an image frame and Pₘᵢₙ is set to ⅙ as described below. In one embodiment, the apparatus 10, such as the processor 12, is also configured to normalize the distance of motion block shift between adjacent frames by dividing the magnitude of the shift by the width, such as the number of columns, of the image frame, such as 8 in the example embodiment depicted in FIG. 4.

Although the shift distance for a forward-backward gesture in an instance in which the apparatus 10 is laid upon a horizontal surface with the camera 20 facing upwards may be determined in the same manner as described above in regards to a left-right gesture, the shift distance may be defined differently for an up-down gesture. In this regard, the shift distance for an up-down gesture in an instance in which the apparatus is laid upon a horizontal surface with the camera facing upwards may be the sum of shift distances for both the left and right borders in the moving block histograms because only the shift distance of the left or right histogram border may not be sufficient for detection. Additionally and as described below, Pₘᵢₙ, P_{range}, Dₘᵢₙ and D_{range} for an up-down gesture may be the same as for other types of gesture, including a forward-backward gesture.

In one embodiment, the apparatus 10 may include means, such as the processor 12 or the like, for determining the evaluation score based upon the motion blocks in the image area and the shift of motion blocks between the image frames as shown in block 34 of FIG. 2. In this regard, the apparatus 10, such as the processor 12, of one embodiment may be configured to determine the evaluation score for the series of image frames to be S_{c}=S_{cp}S_{cd} in which S_{cp}=(P_{mb}−Pₘᵢₙ)/P_{range} and S_{cd}=(Dₕ−Dₘᵢₙ)/D_{range}. In this regard, P_{mb} is the ratio of average effective motion blocks in the entire image area and may be defined as the average percentage of effective motion blocks in each image of the sequence. In addition, Pₘᵢₙ is the minimum number of motion blocks in the image that is required for hardware detection as expressed in terms of a percentage of the total number of blocks in the image frame, such as ⅙ in one example. In an instance in which the number of motion blocks is less than Pₘᵢₙ, the corresponding image frame is set I is set aside or abandoned during the detection process. Dₕ is the shifting distance of the histogram borders in the sequence. Dₘᵢₙ is the minimum distance of the histogram border moving for hardware detection, again expressed in terms of a percentage of the maximum amount by which the histogram border could move, such as ⅛ in one example. P_{range} and D_{range} are the range of moving block percentage and the shifting of the histogram border for normalization. The values for P_{range}, D_{range}, Pₘᵢₙ and Dₘᵢₙ may be defined by experiments to ensure an even distribution from 0 to 1 for S_{cp} and S_{cd}. However, the apparatus 10, such as the processor 12, of other embodiments may determine the evaluation score for the series of images based upon the motion blocks in the image area and the shift of the motion blocks between image frames in other manners. In the example embodiment, it is noted that both S_{cp} and S_{cd} have maximum values of 1 and minimum values of 0.

By way of further description with respect to P_{range} and D_{range}, an analysis of the collected signal data may permit P_{range} and D_{range} to be set so that a predefined percentage, such as 70%, of the moving block percentages are less than P_{range} and a predefined percentage, such as 70%, of the histogram border shiftings in the hand wave sequences are less than D_{range}. Although P_{range} may be less than ½, the moving block percentage is generally near the value in the sequence of the hand wave. For certain frame(s), such as frame t-1 in FIG. 4, the moving block percentage may be larger than P_{range} since the hand may cover the majority of the image. In most images from the hand wave sequence, however, there will be less than 1 frame with a very high moving block percentage. However, the P_{range} value is generally set to take all of the valid frames into consideration. With respect to D_{range}, the value is similar, but is defined as the mean value of the histogram border shifting within a predefined number, e.g., 3, successive frames from the hand wave sequences.

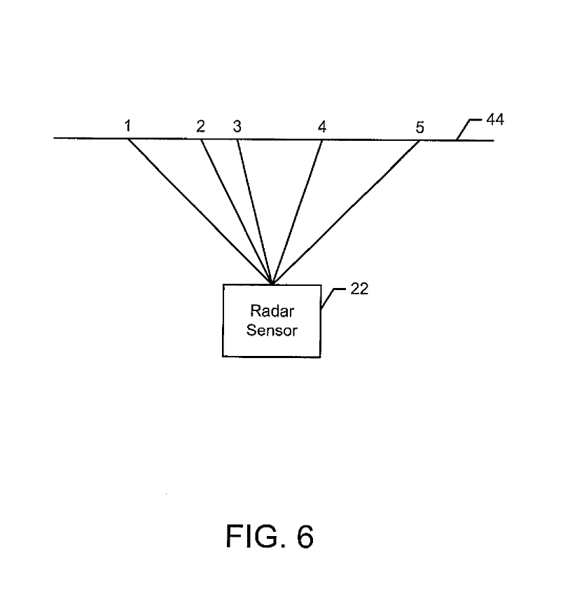

With reference to block 36 of FIG. 2, the apparatus 10 of one embodiment also includes means, such as the processor 12 or the like, for determining an evaluation score for the sequence of radar signals that is indicative of the gesture, that is, is indicative of the likelihood that a gesture is recognized from the sequence of radar signals. In one embodiment, the determination of the evaluation score is based upon the sign distribution in the sequence of radar signals and the intensity distribution in the sequence of radar signals. In this regard, reference is made to FIG. 6 in which a radar sensor 22 is illustrated to be displaced from a plane 44 in which a gesture, such as a hand wave, is made. As will be understood, the hand wave may either move right to left relative to the radar sensor 22 or left to right relative to the radar sensor. Regardless of the direction of movement of the object, e.g., hand, that makes the gesture, the radar sensor 22 may generate signals that are indicative of the distance to the object from the radar sensor and the direction of motion of the object relative to the radar sensor. In this regard, the radar signals may include both an intensity, that is, a magnitude, that may be representative of the distance between the object that makes the gesture and the radar sensor 22 and a sign, such as positive or negative, associated with the radar signals that depends on the direction of motion of the object relative to the radar sensor.

By way of an example in which a hand moves from left to right relative to the radar sensor, the radar sensor may provide the following radar signals: 20, 13, 11, −12, −20 designated 1, 2, 3, 4 and 5, respectively, in FIG. 6. In this embodiment, the intensity of the radar signals refers to detected radial Doppler velocities which, in turn, at constant hand speed relates to the distance of the object to the radar sensor 22, while the sign of the radar signals denotes the direction of movement, that is, whether the hand is moving toward the radar sensor in the case of a positive sign or away from the radar sensor in the case of a negative sign. The foregoing sequence of radar signals therefore indicates that the hand approaches a radar sensor 22 as indicated by the decreasing positive intensities and then moves away from the radar sensor as indicated by the subsequent increasingly negative intensities.

Based upon the radar signals, the apparatus 10, such as the processor 12, may initially determine the mean of the absolute values of the radar signal sequence R comprised of radar signals rᵢ and having a length N. The mean of the absolute values advantageously exceeds a predefined threshold to insure that the sequence of radar signals represents a gesture and is not simply random background movement. In an instance in which the mean of the absolute values satisfies the predefined threshold such that the sequence of radar signals is considered to represent a gesture, the apparatus, such as the processor, may determine whether the gesture is parallel to the display plane or perpendicular to the display plane. In one embodiment, the

apparatus, such as the processor, may determine if

$$\vert \frac{{\sum }_{i = 1}^{N} sign ( {r}_{i} )}{N} \vert$$

satisfies a predefined threshold, such as by being smaller than the predefined threshold. If

$$\vert \frac{{\sum }_{i = 1}^{N} sign ( {r}_{i} )}{N} \vert$$

is smaller than the predefined threshold, the gesture may be interpreted to be parallel to the display plane, while if

$$\vert \frac{{\sum }_{i = 1}^{N} sign ( {r}_{i} )}{N} \vert$$

equals or exceeds the predefined threshold, the gesture may be interpreted to be perpendicular to the display plane.

In an instance in which the gesture is interpreted to be parallel to the display plane, the apparatus 10, such as the processor 20, may then determine the evaluation score based upon the sign distribution in the sequence of radar signals and the intensity distribution in the sequence of radar signals. By way of example, a sequence of radar signals may be defined to be rᵢ with i=1, 2, 3, . . . N. In this embodiment, the effectiveness Eₒᵣᵢ of sign distribution in this sequence may be defined to be equal to (Eₒᵣᵢ₁+Eₒᵣᵢ₂)/2. In order to determine the effectiveness of the sign distribution in the sequence of radar signals, the apparatus 10, such as the processor 12, may divide the sequence of radar signals into two portions, that is, R₁ and R₂. The length of R₁ and R₂ may be N_{R1} and N_{R2}, respectively. In this regard, R₁ and R₂ may be defined as follows: R₁={rᵢ}, i=1, . . . N_{H}, R₂={rᵢ}, i=N_{H+1} . . . , N. In this example, N_{H} is the half position of the sequence of radar signals and may, in turn, be defined as:

$${N}_{H} = \{ \begin{matrix}\frac{N}{2} , & if N is even \\ \frac{N + 1}{2} , & if N is odd\end{matrix}$$

As such, the apparatus 10, such as the processor 12, of this embodiment may define Eₒᵣᵢ₁ and Eₒᵣᵢ₂ as follows:

$${E}_{ori 1} = \frac{{\sum }_{i = 1}^{{N}_{H}} sign ( {r}_{i} )}{{N}_{R 1}}$$

and

$${E}_{ori 2} = \vert \frac{{\sum }_{i = {N}_{H - 1}}^{N} sign ( {r}_{i} )}{{N}_{R 2}} .$$

In this example, it is noted that if Eₒᵣᵢ₁ or Eₒᵣᵢ₂ is negative, the respective value will be set to zero.

The apparatus 10, such as the processor 12, of this embodiment may also determine the effectiveness Eᵢₙₜ of the intensity distribution in the sequence of radar signals. In one example, the effectiveness Eᵢₙₜ of the intensity distribution in the sequence of radar signals is defined as:

$${E}_{int} = 1 \vert \vert \frac{{\sum }_{i = 1}^{N} {r}_{i}}{Nmean ( \vert R \vert )} \vert .$$

Based upon the effectiveness Eₒᵣᵢ of the sign distribution in the sequence of radar signals and the effectiveness Eᵢₙₜ of the intensity distribution in the sequence of radar signals, the apparatus 10, such as the processor 12, of this embodiment may determine the evaluation score for the sequence of radar signals to be Sᵣ=Eₒᵣᵢ Eᵢₙₜ with the score varying between 0 and 1.

In another instance in which the gesture is determined to be perpendicular to the display plane, the apparatus 10, such as the processor 20, may initially determine the direction of movement based upon

$$\frac{{\sum }_{i = 1}^{N} sign ( {r}_{i} )}{N} .$$

In an instance in which this quantity is greater than 0, the hand is determined to be approaching the apparatus, while the hand will be determined to be moving away from the apparatus in an instance in which this quantity is less than 0. In this embodiment, the intensity and the score may vary between 0 and 1 and may both be determined by the apparatus, such as the processor as follows:

$${E}_{int} = {S}_{r} = \vert \frac{{\sum }_{i = 1}^{N} {r}_{i}}{Nmean ( \vert R \vert )} \vert$$

As shown in block 38 of FIG. 2, the apparatus 10 may also include means, such as the processor 12 or the like, for weighting each of the evaluation scores. In this regard, the evaluation scores of the series of image frames and the sequence of radar signals may be weighted based upon the relevance that the series of image frames and the sequence of radar signals have in regards to the identification of a gesture. In some instances, a series of image frames may be more highly weighted as the series of image frames may provide more valuable information for the identification of a gesture than the sequence of radar signals. Conversely, in other instances, the sequence of radar signals may be more greatly weighted since the sequence of radar signals may provide more valuable information regarding the recognition of a gesture than the series of image frames. The apparatus 10 may therefore be trained based upon a variety of factors, such as the context of the apparatus as determined, for example, by other types of sensor input, e.g., sensor input from accelerometers, gyroscopes or the like, in order to weight the evaluation scores associated with the series of image frames and the sequence of the radar signals such that the likelihood of successfully identifying a gesture is increased, if not maximized.

In this regard, the apparatus 10, such as the processor 12, of one embodiment may define a weight factor w=(w_{c},wᵣ) in which w_{c}and wᵣ are the respective weights associated with the series of image frames and the sequence of radar signals, respectively. While the respective weights may be determined by the apparatus 10, such as the processor 12, in various manners, the apparatus, such as the processor, of one embodiment may determine the weights by utilizing, for example, a linear discriminate analysis (LDA), a Fisher discriminate analysis or a linear support vector machine (SVM). In this regard, the determination of the appropriate weights to be assigned the evaluation scores for the series of image frames and the sequence of radar signals is similar to the determination of axes and/or planes that separate two directions of a hand wave. In an embodiment that utilizes LDA in order to determine the weights, the apparatus 10, such as the processor 12, may maximize the ratio of the inter-class distance to the intra-class distance with the LDA attempting to determine a linear transformation to achieve the maximum class discrimination. In this regard, classical LDA may attempt to determine an optimal discriminate subspace, spanned by the column vectors of a projection matrix, to maximum the inter-class separability and the intra-class compactness of the data samples in a low-dimensional vector space.

As shown in operation 40 of FIG. 2, the apparatus 10 may include means, such as the processor 12 or the like, for fusing the evaluation score S_{c} for the series of image frames and the evaluation score Sᵣ for the sequence of radar signals. Although the evaluation scores may be fused in various manners, the apparatus 10, such as the processor 12, may multiple each evaluation score by the respective weight and may then combine the weighted evaluation scores, such as by adding the weighted evaluation scores, e.g., w_{c}S_{c}+wᵣSᵣ. Based upon the combination of the weighted evaluation scores, such as by comparing the combination of the weighted evaluation scores to a threshold, the apparatus 10, such as the processor 12, may determine if the series of image frames and the sequence of radar signals captured a gesture, such as a hand wave, such as in an instance in which the combination of the weighted evaluation scores satisfies a threshold, e.g., exceeds a threshold.

In one embodiment, the apparatus 10, such as the processor 12, may be trained so as to determine the combination of the weighted evaluation scores for a number of different movements. As such, the apparatus 10, such as the processor 12, may be trained so as to identify the combinations of weighted evaluation scores that are associated with a predefined gesture, such as a hand wave, and, conversely, the combinations of weighted evaluation scores that are not associated with a predefined gesture. The apparatus 10 of one embodiment may therefore include means, such as the processor 12 or the like, for identifying a gesture, such as a hand wave, based upon the similarity of the combination of weighted evaluation scores for a particular series of image frames and a particular sequence of radar signals to the combinations of weighted evaluation scores that were determined during training to be associated with a predefined gesture, such as a hand wave, and the combinations of weighted evaluation scores that were determined during training to not be associated with a predefined gesture. For example, the apparatus 10, such as the processor 12, may utilize a nearest neighbor classifier C_{NN} to identify a gesture based upon these similarities.

As shown in operation 42 of FIG. 2, the apparatus 10 may also include means, such as the processor 12 or the like, for determining a direction of motion of a gesture. In this regard, the apparatus 10, such as the processor 12, may determine the direction of movement of the first, e.g., left, border and/or the second, e.g., right, border between a series of image frames and based upon the direction of movement of one or both borders may determine the direction of motion of the gesture. Indeed, the direction of motion of the gesture will be same as the direction of movement of one or both borders of the series of images. Accordingly, a method, apparatus 10 and computer program product of an embodiment of the present invention may efficiently identify a gesture based upon input from two or more sensors, thereby increasing the reliability with which the gesture may be identified and the action taken in response to the gesture.

As described above, FIGS. 2 and 3 illustrate flowcharts of an apparatus 10, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 14 of an apparatus 10 employing an embodiment of the present invention and executed by a processor 12 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-22. (canceled)

23. A method comprising:
receiving a series of image frames;
receiving a sequence of radar signals;
determining an evaluation score for the series of image frames that is indicative of a gesture, wherein determining the evaluation score comprises determining the evaluation score based upon motion blocks in an image area and a shift of motion blocks between image frames;
determining an evaluation score for the sequence of radar signals that is indicative of the gesture, wherein determining the evaluation score comprises determining the evaluation score based upon sign distribution in the sequence and intensity distribution in the sequence;
weighting each of the evaluation scores; and
fusing the evaluation scores, following the weighting, to identify the gesture.

24. A method of claim 23 wherein determining the evaluation score for the series of image frames comprises:
down-sampling image data to generated down-sampled image blocks for the series of image frames;
extracting a plurality of features from the down-sampled image blocks; and
determining a moving status of the down-sampled image blocks so as to determine the motion blocks based upon changes in values of respective features in consecutive image frames.

25. A method of claim 24 further comprising determining a direction of motion of the gesture based on movement of a first border and a second border of a projection histogram determined based on the moving status of respective down-sampled image blocks.

26. A method of claim 23 wherein determining an evaluation score for the series of image frames comprises determining the evaluation score based upon a ratio of average motion blocks in the image area.

27. A method of claim 23 wherein a magnitude of the radar signals depend upon a distance between an object that makes the gesture and a radar sensor, and a sign associated with the radar signals depends upon a direction of motion of the object relative to the radar sensor.

28. A method of claim 23 wherein weighting each of the evaluation scores comprises determining weights to be associated with the evaluation scores based upon linear discriminant analysis, Fisher discriminant analysis or linear support vector machine.

29. A method of claim 23 further comprising determining a direction of motion of the gesture based upon the series of image frames in an instance in which the gesture is identified.

30. An apparatus comprising at least one processor and at least one memory including computer program code, the at least one memory and the computer program code configured to, with the processor, cause the apparatus to:
receive a series of image frames;
receive a sequence of radar signals;
determine an evaluation score for the series of image frames that is indicative of a gesture by determining the evaluation score based upon motion blocks in an image area and a shift of motion blocks between image frames;
determine an evaluation score for the sequence of radar signals that is indicative of the gesture by determining the evaluation score based upon sign distribution in the sequence and intensity distribution in the sequence;
weight each of the evaluation scores; and
fuse the evaluation scores, following the weighting, to identify the gesture.

31. An apparatus of claim 30 wherein the at least one memory and the computer program code are configured to, with the processor, cause the apparatus to determine the evaluation score for the series of image frames by:
down-sampling image data to generated down-sampled image blocks for the series of image frames;
extracting a plurality of features from the down-sampled image blocks; and
determining a moving status of the down-sampled image blocks so as to determine the motion blocks based upon changes in values of respective features in consecutive image frames.

32. An apparatus of claim 31 wherein the at least one memory and the computer program code are further configured to, with the processor, cause the apparatus to determine a direction of motion of the gesture based on movement of a first border and a second border of a projection histogram determined based on the moving status of respective down-sampled image blocks.

33. An apparatus of claim 30 wherein the at least one memory and the computer program code are configured to, with the processor, cause the apparatus to determine an evaluation score for the series of image frames by determining the evaluation score based upon a ratio of average motion blocks in the image area.

34. An apparatus of claim 30 wherein a magnitude of the radar signals depend upon a distance between an object that makes the gesture and a radar sensor, and a sign associated with the radar signals depends upon a direction of motion of the object relative to the radar sensor.

35. An apparatus of claim 30 wherein the at least one memory and the computer program code are configured to, with the processor, cause the apparatus to weight each of the evaluation scores by determining weights to be associated with the evaluation scores based upon linear discriminant analysis, Fisher discriminant analysis or linear support vector machine.

36. An apparatus of claim 30 wherein the at least one memory and the computer program code are further configured to, with the processor, determine a direction of motion of the gesture based upon the series of image frames in an instance in which the gesture is identified.

37. The apparatus of claim 30, further comprising user interface circuitry configured to:
facilitate user control of at least some functions of the apparatus through use of a display; and
cause at least a portion of a user interface of the apparatus to be displayed on the display to facilitate user control of at least some functions of the apparatus.

38. A computer program product comprising at least one computer-readable storage medium having computer-executable program code portions stored therein, the computer-executable program code portions comprising program instructions configured to:
receive a series of image frames;
receive a sequence of radar signals;
determine an evaluation score for the series of image frames that is indicative of a gesture by determining the evaluation score based upon motion blocks in an image area and a shift of motion blocks between image frames;
determine an evaluation score for the sequence of radar signals that is indicative of the gesture by determining the evaluation score based upon sign distribution in the sequence and intensity distribution in the sequence;
weight each of the evaluation scores; and
fuse the evaluation scores, following the weighting, to identify the gesture.

39. A computer program product of claim 38 wherein the program instructions configured to determine the evaluation score for the series of image frames comprise program instructions configured to:
down-sample image data to generated down-sampled image blocks for the series of image frames;
extract a plurality of features from the down-sampled image blocks; and
determine a moving status of the down-sampled image blocks so as to determine the motion blocks based upon changes in values of respective features in consecutive image frames.

40. A computer program product of claim 39 wherein the computer-executable program code portions further comprise program instructions configured to determine a direction of motion of the gesture based on movement of a first border and a second border of a projection histogram determined based on the moving status of respective down-sampled image blocks.

41. A computer program product of claim 38 wherein the program instructions configured to determine an evaluation score for the series of image frames comprise program instructions configured to determine the evaluation score based upon a ratio of average motion blocks in the image area.
